(19) United States
(12) Patent Application Publication
(10) Pub. No.: US 2023/0210239 A1
(43) Pub. Date: Jul. 6, 2023

(54) ADHESIVE GEL NAIL AND MANUFACTURING METHOD THEREOF

(71) Applicant: Jin Woong JOO, Seoul (KR)

(72) Inventor: Jin Woong JOO, Seoul (KR)

(21) Appl. No.: 17/927,710

(22) PCT Filed: Apr. 9, 2021
(86) PCT No.: PCT/KR2021/004486

§ 371 Date: Nov. 24, 2022

(30) Foreign Application Priority Data
Mar. 29, 2021 (KR) 10-2021-0040459

(51) Int. Cl. A45D 29/00; A45D 31/00

(52) U.S. Cl. CPC A45D 29/001; A45D 31/00

(57) ABSTRACT

An adhesive gel nail includes: an adhesive layer; a color base layer formed on a top of the adhesive layer; a color printing layer formed on a top of the color base layer; a gel coating layer formed on a top of the color printing layer; and a decorative layer formed on a top of the gel coating layer, wherein a lower surface of the decorative layer is disposed on the color base layer.

### TECHNICAL FIELD

The present invention relates to an adhesive gel nail and a manufacturing method thereof, and more particularly, to an adhesive gel nail including a decorative layer such as stone and a method for manufacturing the same.

### BACKGROUND TECHNOLOGY

Generally, in the case of nail art, pigments such as nail polish of various colors have been applied to nails or toenails, or accessories such as beads or jewels are attached to the nails.

However, this method of applying liquid pigments to nails or toenails may cause inconvenience to the user because it takes a lot of time to harden the pigment after applying it. Also, even when attaching an accessory, it takes time until the adhesive is completely hardened, and there was a problem that the accessory could easily fall off with a small impact even after attachment was completed.

In order to solve these problems, a method of attaching a nail sticker is used instead of directly applying a pigment to the user's nails or toenails. According to this method, the user can decorate the nails and toenails simply by attaching a sticker to the nail or toenail without having to wait until the pigment is applied and hardened, so the user can perform nail art much more quickly and easily compared to the conventional method.

Furthermore, as described in prior arts 1 to 4, a method for maintaining the shape attached to the nail or toenail by performing UV curing after attaching the sticker in a soft semi-solid state to the nail or toenail has recently been proposed.

However, in prior arts 1 to 4, there is a problem of implementing a color layer on an adhesive layer or an adhesive layer. In other words, the color layer in the gel nail plays an important role in determining the color of the gel nail sticker, and prior arts 1 to 4 form a color layer directly on the adhesive layer or the adhesive layer, so the problem of poor colorability occurs.

Furthermore, in line with the trend of upgrading products, products that attach a decorative layer made of stone (stone) or metal to the outermost angle of gel nails are appearing recently. However, since the adhesive is applied and attached by hand in order to attach these decorative layers separately, there is a problem that the price of the product is significantly increased, and the decorative layer is easily peeled off, and the quality of gel nails is deteriorated.

### PRIOR ARTS

### Patent Document

(Patent document 1) Korean Registration Patent No. 10-2024663 (2019.09.24) Gel Nail Sticker

(Patent document 2) Korean Registration Patent No. 10-2024666 (2019.09.24) Manufacturing method of gel nail stickers

(Patent document 3) Korean Registration Patent No. 10-11949267 (2019.02.19) Gel nail stickers and their manufacturing methods

(Patent document 4) Korean Registration Patent No. 10-1797203 (2017.11.15) Radio-cured gel nail sticker for nail art and its manufacturing method

### DETAILED EXPLANATION OF THE INVENTION

### Technical Challenges

The present invention is to solve the problems of the above prior arts, and an object of the present invention is to provide an adhesive gel nail that can firmly attach an additional decorative layer to the gel nail and a manufacturing method thereof.

Furthermore, the object of the present invention is to provide an adhesive gel nail with markedly increased colorability or durability, and a manufacturing method thereof

### Technical Solution

The adhesive gel nail according to one aspect of the present invention includes an adhesive layer, a color base layer formed on the upper part of the adhesive layer, a color printing layer formed on the upper part of the color base layer, a gel coating layer formed on the upper part of the color printing layer, and a decorative layer formed on the upper part of the gel coating layer, and the lower surface of the decorative layer is arranged on the color base layer.

At this time, the color base layer can be formed of a urethane material.

Also, the color base layer can be formed in a structure where an open cell and a closed cell are mixed.

Also, the surface roughness of the color base layer can be formed smaller than the surface roughness of the adhesive layer.

Also, a gel protrusion with the gel coating layer protruding from the side surface of the decorative layer can be formed.

Also, the gel protrusion may be formed to cover the border of the decorative layer.

Also, an adhesive layer can be formed on the lower surface of the decorative layer.

Also, an opening is formed inside the decorative layer, and an adhesive layer can be filled and formed in the opening.

Also, a tissue fusion part in which the adhesive layer and the gel coating layer are thermally fused can be formed on the lower surface of the decorative layer.

Furthermore, a release paper arranged on the lower surface of the adhesive layer is further included, and a compression mark corresponding to the border of the decorative layer can be generated on the release paper.

Also, the color printing layer can be cured by ultraviolet rays while in contact with the color base layer.

On the other hand, the method for manufacturing an adhesive gel nail according to one aspect of the present invention includes the steps of forming an adhesive layer, forming a color base layer on the adhesive layer, forming a color printing layer on the color base layer, forming a gel coating layer on the color printing layer, and forming a decorative layer on the gel coating layer, and the lower surface of the decorative layer can be arranged on the color base layer.

### Effects of the Invention

The adhesive gel nail according to the present invention and the manufacturing method thereof enable large-scale production while maximizing the adhesion of decorations such as stones by arranging the lower surface of the decorative layer on a color base layer.

Furthermore, the present invention increases the colorability and resolution of the color printing layer by forming the color base layer with polyurethane.

### BRIEF DESCRIPTION OF THE DRAWING

FIG. 1 is a cross-sectional view of an adhesive gel nail according to a first embodiment of the present invention.

FIG. 2 is a cross-sectional view of an adhesive gel nail according to a second embodiment of the present invention.

FIG. 3 is a cross-sectional view of an adhesive gel nail according to a third embodiment of the present invention.

FIG. 4 is a cross-sectional view of an adhesive gel nail according to a fourth embodiment of the present invention.

FIG. 5 is a cross-sectional view of an adhesive gel nail according to a fifth embodiment of the present invention.

FIG. 6 is a cross-sectional view of an adhesive gel nail according to a sixth embodiment of the present invention.

FIG. 7 is a top image of an adhesive gel nail according to the first embodiment of the present invention.

FIG. 8 is a lower image of an adhesive gel nail according to the first embodiment of the present invention.

FIG. 9 is a flow diagram showing a method for manufacturing adhesive gel nails according to the first embodiment of the present invention.

### DESCRIPTION OF EMBODIMENT OF INVENTION

Hereafter, with reference to the accompanying drawings, an embodiment of the present invention will be described in detail so that those skilled in the art can easily implement it. Since the present invention can have various changes and various embodiments, it will be described in detail by exemplifying specific embodiments in the drawings. However, this is not intended to limit the present invention to specific embodiments, and should be understood to include all modifications, equivalents, and substitutes included in the spirit and scope of the present invention.

Terms including ordinal numbers, such as first and second, may be used to describe various components, but the components are not limited by the terms. These terms are only used for the purpose of distinguishing one component from another.

For example, a first element may be termed a second element, and similarly, a second element may be termed a first element, without departing from the scope of the present invention. The terms and/or include any combination of a plurality of related recited items or any of a plurality of related recited items.

Unless defined otherwise, all terms used herein, including technical or scientific terms, have the same meaning as commonly understood by one of ordinary skill in the art to which the present invention belongs. Terms such as those defined in commonly used dictionaries should be interpreted as having a meaning consistent with the meaning in the context of the related art, and unless explicitly defined in the present application, they should not be interpreted in an ideal or excessively formal meaning.

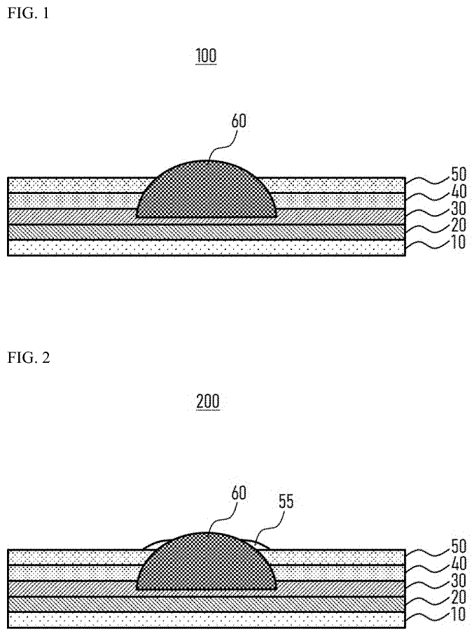

Hereafter, an adhesive gel nail according to the first embodiment of the present invention is described. FIG. 1 is a cross-sectional view of an adhesive gel nail according to the first embodiment of the present invention.

Referring to FIG. 1, an adhesive gel nail (100) according to the first embodiment of the present invention is comprised of including) an adhesive layer (20), a color base (30), a color printing layer (40), a gel coating layer (50), and a decorative layer (60). At this time, the adhesive layer (20) is formed on the release paper (10) for its manufacture.

First, the release paper (10) acts as a support to form the adhesive layer (20) and can be located at the bottom of the adhesive gel nail (100). This release paper (10) can be removed when the adhesive gel nail (100) is used. More specifically, the release paper (10) may include a silicone release treatment fabric in a PET material.

The adhesive layer (20) includes at least one of acrylic water-based, acrylic oil-based, and UV-curable adhesives, and refers to the part that directly adheres to the user's nails or toenails. This adhesive layer (20) is formed by applying it on the release paper (10).

The adhesive layer (20) may include a nutrient enhancing component for caring for nails and toenails and an antibacterial component for protecting nails from bacteria, mold, etc., as an anti-puncture nutritional glue layer.

More specifically, the adhesive layer (20) comprises at least one of vitamins, calcium, eucalyptus, cypress water, and natural herbs. At this time, vitamin B5, vitamin E, calcium, etc. can be included as nutrition-enhancing ingredients, and eucalyptus, cypress water, and natural herbs can be included as antibacterial components.

That is, since the adhesive gel nail according to the present embodiment contains both a nutrition-enhancing component and an antibacterial component, it is possible to protect the nails and toenails of users damaged by frequent self-nail procedures and minimize damage to the nail surface.

The color base layer (30) is formed on top of the adhesive layer (20), and can be formed to generate an air hole by adding an aerosol to the urethane raw material. Alternatively, the internal structure of the color base layer can be formed as a mixture of open cells and closed cell using a mixture of urethane raw materials, and it is desirable to form the open cell's volume % ratio of 5% or more to ensure minimal breathability.

With such a color base layer (30), the adhesive gel nail (100) can have breathability due to increased oxygen permeability, so that when the user attaches the gel nail (100) to the nail or toenail, it is possible to have a more comfortable fit without feeling stuffy. At this time, the urethane sheet layer (30) may have a thickness of 20 to 50 um.

Furthermore, the color base layer (30) is located below the color printing layer (40) and can be made of a white series. Therefore, in the adhesive gel nail (100) according to the present embodiment, CMYK is mixed or color ink mixed with other colors is applied to the white color base layer (30) to indicate a desired color in the color printing layer (40), so the color resolution of the color layer is increased and the pattern of the color printing layer (40) can be more clearly confirmed.

Furthermore, in this case, the surface roughness of the color base layer (40) is formed to be smaller than the surface roughness of the adhesive layer (20). When the color printing layer (40) is applied directly to the adhesive layer (20), the printing resolution is greatly reduced due to the surface roughness of the adhesive layer (20). However, if the color base layer (30) composed of a polyurethane film is first bonded to the adhesive layer (20) and a color or pattern is printed thereon, the printing resolution can be maximized. Therefore, as the resolution increases along with the increase in saturation described above, it becomes possible to implement more microscopic patterns or shapes.

Furthermore, the color base layer (30) supports the color printing layer (40) when the color printing layer (40) is cured by ultraviolet light. That is, since the color base layer (30) has a breathable structure as described above, it is flexible but has a significantly greater tensile strength than the adhesive layer (20). Therefore, even when the color printing layer (40) is cured, the durability of the gel nail (100) is significantly increased because the bonding force with the adhesive layer (20) is maintained on the other side while reducing the occurrence of cracks in the color layer (40) because it is deformed together in response to a change in volume of the color printing layer (40).

The color printing layer (40) is applied to the color base layer (30) and can be formed by printing color ink at a fixed thickness. The color ink used in the color printing layer (40) includes CMYK, etc., where C is blue, M is red, Y is yellow, and K is black, and a color printing layer (40) can be formed by using these color inks alone or by mixing them appropriately.

Also, the color printing layer (40) can print the shape pattern of the nail together, and the design can be expressed by various printing methods, gold foil, silver foil, hole foil, or glitter. At this time, the color printing layer (50) can be formed by methods such as silk screen printing, flexographic printing, offset printing, digital printing, and gravure printing.

Meanwhile, the gel coating layer (60) is formed on the color printing layer (40). The gel coating layer (60) comprises a UV gel coating layer (non-illustrated) or an LED gel coated layer (non-illustrated).

The UV gel coating layer can be formed by applying a UV gel coating solution that mixes an oligomer, a monomer, and a short wavelength initiator and drying it using an ultraviolet curing method. For example, the UV gel coating layer can be formed using a UV gel coating solution that mixes 40% to 60% oligomers, 30% to 55% monomers, and 2% to 10% short wavelength initiators. At this time, urethane, acrylic epoxy, polyesther-based oligomers, etc. can be used as oligomers, and TPO, 184, etc. can be used as the short-wavelength initiator. Also, the applied UV gel coating liquid can form a UV gel coating layer by drying it using a UV ultraviolet curing method.

In the case of such a UV gel coating layer, when the oligomer exceeds the standard value (that is, when the oligomer content exceeds 60%), the gel nail (100) becomes too soft, causing deformation of the gel nail, and damage such as scratches and dents may decrease the holding power. Therefore, it is necessary to mix the oligomer so that the content of oligomers does not exceed 60% as much as possible.

Meanwhile, when the oligomer is below the standard value (that is, when the oligomer content is less than 40%), the adhesive gel nail (100) becomes too hard and difficult to apply to the curved nails of ordinary consumers. Therefore, the gel nail (100) may fall off (falling off the nail or toenail) due to poor adhesion, and deformation may occur because there is no sense of adhesion. Therefore, it is desirable to mix the oligomer so that the oligomer content is 40% or more.

On the other hand, if the monomer in the UV gel coating layer exceeds the standard value (for example, 55% content), the flexibility and elongation of the product may decrease, and the adhesion to curved nails or toenails may decrease, so the durability may deteriorate. On the other hand, if the monomer content is below the standard value (for example, 30%), the adhesive gel nail (100) becomes too hard, so it is desirable to mix the monomer in the range of 30% to 55% as the adhesion decreases when applied to curved nails.

Here, adhesion to nails or toenails means that the adhesive layer (20) provided on the release paper (10) in the adhesive gel nail (100) is attached as it is without falling off the user's curved nails or toenails. By improving the adhesiveness of the adhesive layer (20), the adhesive gel nail (100) can achieve excellent adhesion when attached to the nail or toenail.

Also, if the short wavelength initiator exceeds 10% in the UV gel coating layer, the curing state of the product becomes too fast and natural curing may occur during the manufacturing process or distribution process, making it difficult to apply the adhesive gel nail (100) to the user's curved nails or toenails, and the gel nail (100) can easily be peeled off from the nails or toenails even if applied. In order to prevent this phenomenon, in the case of the UV gel coating layer, the short wavelength initiator can be mixed so as not to exceed 10%.

On the other hand, if the short wavelength initiator is below the standard value (for example, 2%), the curing rate may be decreased and the durability of the product may be decreased. For this reason, foreign substances can easily stick to the nails or toenails, deformation can easily occur, and durability may also deteriorate. Therefore, it is desirable to adjust the content so that the content of the short wavelength initiator used in the UV gel coating layer is 2% or more.

The LED gel coating layer can be formed by applying and drying an LED gel coating solution mixed with an oligomer, a monomer, a long wavelength initiator, and cellulose. For example, the LED gel coating layer can be formed using an LED gel coating solution that mixes 15% to 40% oligomers, 20% to w. Also, the applied LED gel coating liquid can form an LED gel coating layer by drying it for 30 to 60 minutes between 60 degrees and 100 degrees. In this way, the UV gel coating layer and the LED gel coating layer may serve to protect the color printing layer (40) as a transparent coating layer. For example, the LED gel coating layer may have a thickness of 220 microns.

In the case of such an LED gel coating layer, if the monomer exceeds a standard value (for example, 30%), the stickiness of the adhesive gel nail (100) may become severe and the durability may decrease. Also, the adhesive gel nail (100) is placed on the user's hand, and the shape of the gel nail (100) may be damaged. The curing speed of the product is also greatly reduced. To prevent this phenomenon, it is desirable to set the monomer content to 30% or less in the LED gel coating layer. On the other hand, if the monomer content is less than 20%, the gel nail (100) becomes too hard, and when applying the gel nail (100) to the curved nail, the adhesion may decrease, and the durability may also decrease. Therefore, it is desirable to have a monomer content of 20% or more.

Meanwhile, if the oligomer contained in the LED gel coating layer exceeds 40%, it can easily be cured to ultraviolet rays. In other words, natural curing can easily occur during the manufacturing or distribution process of the adhesive gel nail (100). Because of this, if the user removes the adhesive gel nail (100) after the LED gel coating layer has been cured, it cannot be completely removed and may split and peel off. In this case, nail damage may occur. On the other hand, if the oligomer is less than 15%, the curing speed is too slow during UV curing, preventing complete hardening, and using an uncured product in such a state may severely damage the adhesive gel nail (100). In this way, the durability of the adhesive gel nail (100) may decrease due to shape deformation, loss of gloss, foreign substances, and the like.

Also, if the long wavelength initiator of the LED gel coating layer exceeds 0.5%, natural curing can easily occur due to exposure to light in real life, making it difficult to easily apply adhesive gel nails (100) to the user's curved nails or toenails, and the gel nail (100) can easily fall off even after application. If the long wavelength initiator is less than 0.1%, the curing speed is too slow, and the durability of the gel nail (100) may be deteriorated. For this reason, foreign substance can easily stick, deformation easily occur, and durability may be deteriorated.

Also, if the cellulose in the LED gel coating layer is mixed to exceed 55%, the elongation rate of the gel nail (100) may be too low, making it difficult to attach it to curved nails or toenails. That is, since the gel nail (100) does not completely adhere to the user's nails or toenails and is not easily removed, the adhesive strength and durability of the gel nail (100) may be r deteriorated. Therefore, it is desirable to mix cellulose to 55% or less in the LED gel coating layer. On the other hand, if the cellulose content is less than 30%, the ability to make the adhesive gel nail (100) semi-solid may decrease, so it is necessary to make the cellulose content 30% or more.

On the other hand, monomers, oligomers, and long-wavelength initiators used in the adhesive gel nail (100) according to the first embodiment of the present invention are all liquid products, and only when exposed to ultraviolet light, they change from a liquid state to a solid state. At this time, cellulose can perform the function of making this liquid gel nail into a semi-solid state.

Meanwhile, a decorative layer (60) is formed on the top of the gel coating layer (50). The decorative layer (60) may be formed from at least one of stone, metal, and synthetic resin materials. However, for the heat welding process described below, it is preferable that the material of the decorative layer is formed of stone or metal.

Furthermore, the lower surface of the decorative layer (60) can be placed on the color base layer (40) to maximize adhesion. The decorative layer (60) is attached by applying a compressive force to the lower surface by a method of thermocompression. In this case, the color base, which is a polyurethane material, is partially melted and adheres to the lower surface of the decorative layer (60). Also, when the surface roughness of the lower surface of the decorative layer is used above the set value, the color base is appropriately inserted into the area causing surface roughness, so the adhesion force is further increased. Since this thermocompression does not require manual work and enables mass automatic production, manufacturing costs are significantly reduced.

Hereafter, an adhesive gel nail (200) according to the second embodiment of the present invention is described. FIG. 2 is a cross-sectional view of an adhesive gel nail according to the second embodiment of the present invention. In this embodiment, the same reference code is assigned to the same configuration as the previous embodiment. Also, in this embodiment, duplicate explanations are omitted for the same configuration as the previous embodiment.

The adhesive gel nail (200) according to the second embodiment of the present invention is characterized by the formation of the gel protrusion (55). As described above, when the decorative layer (60) is attached by the method of thermocompression, the gel protrusion (55) is formed where part of the gel coating layer (50) is melted and protrudes upwards. Since the gel protrusion (55) is formed to cover the border of the decorative layer (60) as shown, the adhesion of the decorative layer (60) can be further maximized.

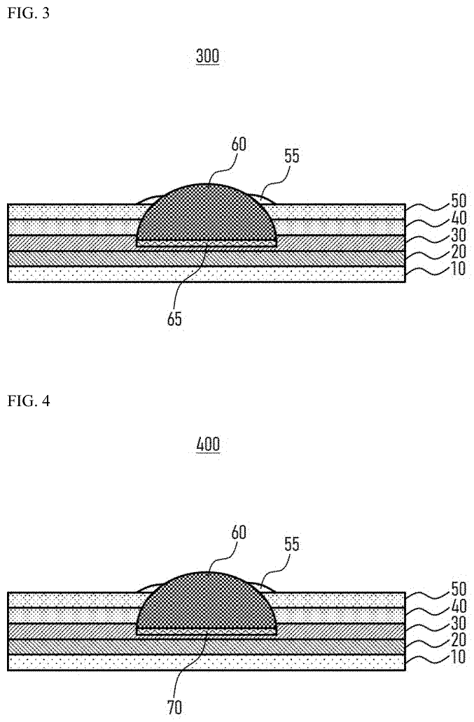

Hereafter, an adhesive gel nail (300) according to the third embodiment of the present invention is described. FIG. 3 is a cross-sectional view of an adhesive gel nail according to the third embodiment of the present invention. In this embodiment, the same reference code is assigned to the same configuration as the previous embodiment. Also, in this embodiment, duplicate explanations are omitted for the same configuration as the previous embodiment.

In this embodiment, an adhesive layer (65) is additionally formed on the underside of the decorative part (60). This adhesive layer (65) performs a role of adhering more closely to the color base layer (30) during the thermocompression, thereby further maximizing the adhesion of the decorative layer (60).

Hereafter, an adhesive gel nail (400) according to the fourth embodiment of the present invention is described. FIG. 4 is a cross-sectional view of an adhesive gel nail according to the fourth embodiment of the present invention. In this embodiment, the same reference code is assigned to the same configuration as the previous embodiment. Also, in this embodiment, duplicate explanations are omitted for the same configuration as the previous embodiment.

In this embodiment, when the decorative layer (60) is thermally pressed, the temperature range is further raised in the previous embodiment, and the adhesive part (65) in the third embodiment is melted and fused with the color base layer (30) to form a tissue fusion part (70). This tissue fusion part (70) further maximizes the adhesion due to simple adhesion.

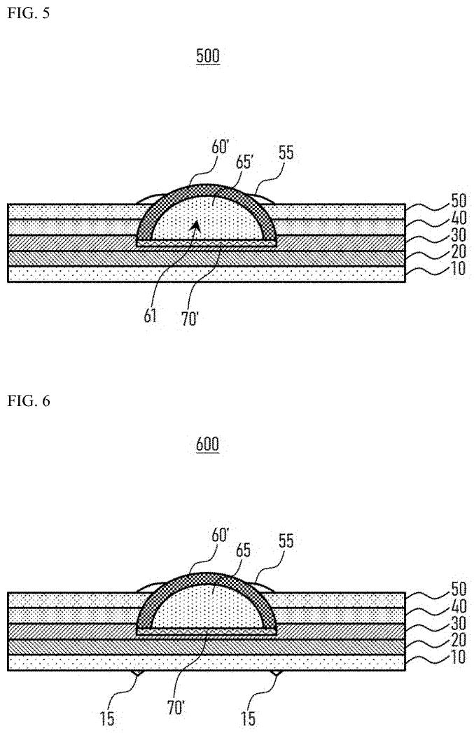

Hereafter, an adhesive gel nail (500) according to the fifth embodiment of the present invention is described. FIG. 5 is a cross-sectional view of an adhesive gel nail according to the fifth embodiment of the present invention. In this embodiment, the same reference code is assigned to the same configuration as the previous embodiment. Also, in this embodiment, duplicate explanations are omitted for the same configuration as the previous embodiment.

In this embodiment, the shape of the decorative layer (60′) was changed. The decorative layer (60′) according to the present embodiment forms an opening (61) which is an empty space inside, and an adhesive layer (65′) is formed in this opening (61).

When this type of decorative layer (60′) is thermally pressed, the internal adhesive is thermally fused with the color printing layer (30) to form a tissue fusion part (70′) of a different type from the previous embodiment.

This tissue fusion part (70′) allows the adhesive layer (65′) to hold the upper decorative layer while the tissue fusion part (70′) more firmly binds the decorative layer (60′) in the lower direction.

Hereafter, an adhesive gel nail (600) according to the sixth embodiment of the present invention is described. FIG. 6 is a cross-sectional view of an adhesive gel nail according to the sixth embodiment of the present invention. In this embodiment, the same reference code is assigned to the same configuration as the previous embodiment. Also, in this embodiment, duplicate explanations are omitted for the same configuration as the previous embodiment.

In this embodiment, it is explained that compression marks (15) are generated on the release paper (10) according to the manufacturing method according to the present embodiment. When pressure below the set range is applied when the decorative layer (60′) is thermally pressed, a problem occurs that the lower surface of the decorative layer (60′) cannot be placed in the color base layer (30), and when pressure above the set range is applied, the decorative layer (60′) comes out through the release paper (10).

Therefore, it is very important to apply pressure within the set range during the thermal compression. In this case, when the pressure in the set range is applied, it is desirable that the release paper (10) is slightly pressed; in this case, it is desirable to apply pressure to the extent that compression marks (15) are generated on the release paper (10).

In other words, compression marks (15) are generated on the release paper (10), but the bottom surface of the decorative layer (60′) is placed on the color base layer (30) when pressure is applied to prevent the release paper (10) from being pierced.

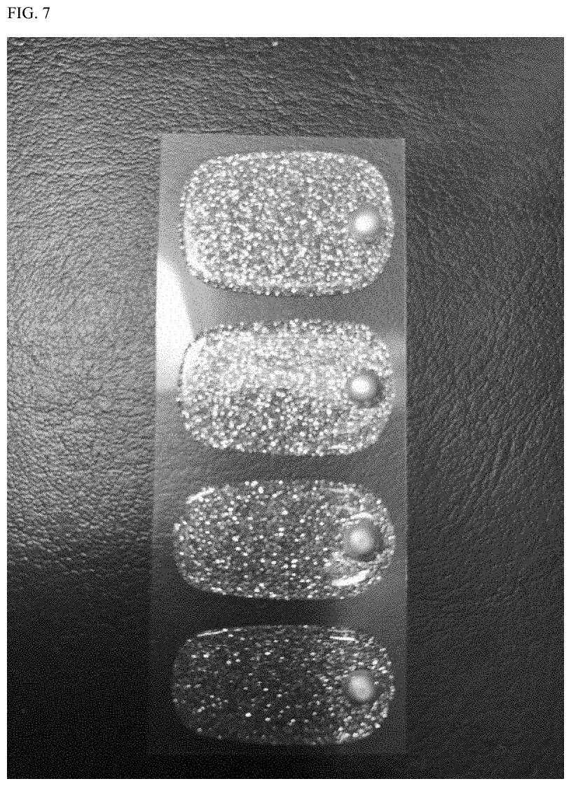

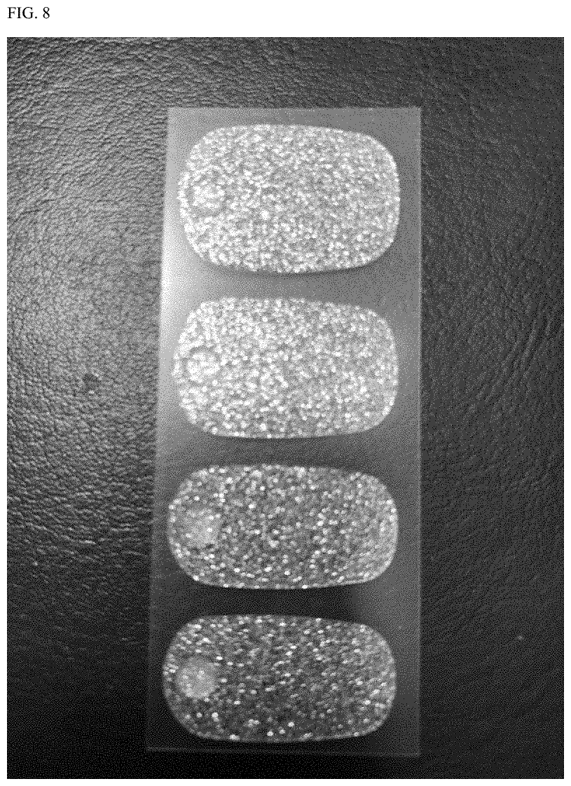

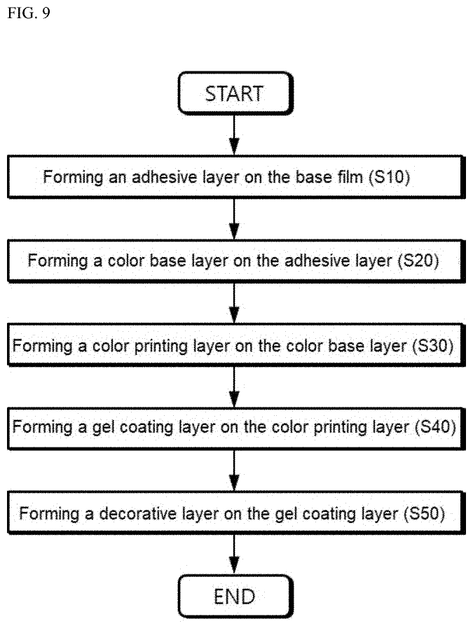

Photographs of adhesive gel nails prepared by the above embodiments are shown in FIG. 7 and FIG. 8. FIG. 7 is an upper image of an adhesive gel nail according to the first embodiment of the present invention, and FIG. 8 is a lower image of the adhesive gel nail according to the first embodiment of the present invention.

As shown in FIG. 7, you can see that another layer is surrounded by the border of the decorative layer. This other layer is the gel coating layer described above. Also, if you refer to FIG. 8, the bottom border of the decorative layer is visible, which shows that pressure was applied to the release paper to cause compression marks.

Hereafter, a method for manufacturing an adhesive gel nail according to an embodiment of the present invention is described. FIG. 9 is a flow diagram showing a method for manufacturing an adhesive gel nail according to the first embodiment of the present invention.

Referring to the drawing, a method for manufacturing an adhesive gel nail according to this embodiment is comprised by including the steps of forming an adhesive layer on the base film (S10), forming a color base layer on the adhesive layer (S20), forming a color printing layer on the color base layer (S30), forming a gel coating layer on the color printing layer (S40), and a decorative layer (S50) on the gel coating layer.

At this time, the overlapping description will be omitted, and in this embodiment, it is most important to form a color base layer on the adhesive layer and to form a decorative layer. At this time, since the adhesive layer is formed first and the color layer is formed thereon, curing the color layer is a major disadvantage that causes cracks. Therefore, even if the white series acts as a color base, but the surface roughness becomes smaller than the adhesive layer and the color layer hardens while increasing printing resolution, the color base layer closely supports the color layer, thereby significantly increasing the durability of the color layer and the entire gel nail.

Also, as described above, the decorative layer is thermally pressed so that a gel protruding part with a gel coating layer protruding from the upper part is formed while the lower surface is placed on the color base layer, and a tissue fusion part in which the adhesive and the color base layer are fused is formed in the lower surface to maximize the impact of the decorative layer.

As described above, desirable embodiments of the present invention are disclosed in the present specification and drawing, and although specific terms are used, they are only used in a general sense to easily explain the technical contents of the present invention and help understand the invention, and are not intended to limit the scope of the present invention. In addition to the embodiments disclosed herein, it is obvious to a person skilled in the art that other variants based on the technical ideas of the present invention can be implemented.

### EXPLANATION OF THE CODE

100, 200, 300, 400, 500, 600: adhesive gel nail

10: release paper

15: compression marks

20: adhesive layer

30: color base layer

40: color printing layer

50: gel coating layer

55: gel protrusion

60: decorative layer

65, 65′: adhesive layer

70, 70′: tissue fusion part

1. An adhesive gel nail, characterized by comprising:
an adhesive layer;
a color base layer formed on a top of the adhesive layer;
a color printing layer formed on a top of the color base layer;
a gel coating layer formed on a top of the color printing layer; and
a decorative layer formed on a top of the gel coating layer;
wherein a lower surface of the decorative layer is disposed on the color base layer.

2. The adhesive gel nail according to claim 1, characterized in that the color base layer is made of a urethane material.

3. The adhesive gel nail according to claim 1, characterized in that the color base layer has a structure in which an open cell and a closed cell are mixed.

4. The adhesive gel nail according to claim 1, characterized in that a surface roughness of the color base layer is smaller than a surface roughness of the pressure-sensitive adhesive layer.

5. The adhesive gel nail according to claim 1, characterized in that a gel protrusion from which the gel coating layer protrudes is formed on a side surface of the decorative layer.

6. The adhesive gel nail according to claim 5, characterized in that the gel protrusion being formed to cover the border of the decorative layer.

7. The adhesive gel nail according to claim 1, characterized in that an adhesive layer is formed on a lower surface of the decorative layer.

8. The adhesive gel nail according to claim 1, characterized in that an opening is formed inside the decorative layer, and an adhesive layer is filled and formed in the opening.

9. The adhesive gel nail according to claim 1, characterized in that a tissue fusion part in which the adhesive layer and the gel coating layer are thermally fused is formed on the lower part of the decorative layer.

10. The adhesive gel nail according to claim 1, characterized by further comprising a release paper arranged on a lower surface of the adhesive layer, wherein a compression mark corresponding to the border of the decorative layer is generated on the release paper.

11. The adhesive gel nail according to claim 1, characterized in that the color printing layer is cured by ultraviolet rays while in contact with the color base layer.

12. A method of manufacturing the adhesive gel nail characterized by comprising:
an adhesive layer;
a color base layer formed on the adhesive layer;
a color printing layer formed on the color base layer;
a gel coating layer formed on the color printing layer; and
a decorative layer formed on the gel coating layer;
wherein a lower surface of the decorative layer is disposed on the color base layer.
